(19) United States
(12) Patent Application Publication
(10) Pub. No.: US 2015/0199461 A1
(43) Pub. Date: Jul. 16, 2015

(54) METHOD AND APPARATUS FOR TIMING VERIFICATION

(71) Applicant: QUALCOMM Incorporated, San Diego, CA (US)

(72) Inventor: Michael LAISNE, Encinitas, CA (US)

(21) Appl. No.: 14/327,394

(22) Filed: Jul. 9, 2014

Related U.S. Application Data
(60) Provisional application No. 61/928,393, filed on Jan. 16, 2014.

(51) Int. Cl. G06F 17/50

(52) U.S. Cl. CPC G06F 17/5031; G06F 2217/84

(57) ABSTRACT

In one configuration, the method for verifying a test vector includes simulating a pattern on a netlist of the IC and selecting at least one path in the netlist of the IC based on a result of the simulation. The method further includes generating timing information of the at least one path and storing the timing information of the at least one path. In another configuration, the apparatus for verifying a test vector of the (IC) includes a memory and at least one processor coupled to the memory. The at least one processor is configured to simulate a pattern on a netlist of the IC, to select at least one path in the netlist of the IC based on a result of the simulation, to generate timing information of the at least one path, and to store the timing information of the at least one path.

### CROSS-REFERENCE TO RELATED APPLICATION(S)

This application claims the benefit of U.S. Provisional Application Ser. No. 61/928,393, titled “METHOD AND APPARATUS FOR VERIFYING TIMING BASED VECTORS USING A SINGLE ZERO GATE DELAY SIMULATION” and filed on Jan. 16, 2014, which is expressly incorporated by reference herein in its entirety.

### BACKGROUND

1. Field

The disclosure relates to a design methodology of integrated circuits (ICs), and, in particular, to the verification of vectors.

2. Background

Wireless communication technologies and devices (e.g., cellular phones, tablets, laptops, etc.) have grown in popularity and use over the past several years. Increasingly, mobile electronic devices have grown in complexity and now commonly include multiple processors and other resources that allow mobile device users to execute complex and power intensive software applications (e.g., music player, web browsers, video streaming applications, etc.). As a result, ICs contained in the wireless device (e.g., baseband processor and application processor) have become more complicated as the size of their features decrease.

ICs contain many transistors and other circuit elements, all of which must perform as expected while meeting various process, voltage, and temperature (PVT) requirements. Simulation may be used to check timing and ensure that a new chip or device meets planned specifications. The timing may need to be verified, for example, prior to device tape-out and before finalizing a build in silicon as changes after the tape-out and the build in silicon are costly and time-consuming. An example of the simulation may be to run test vectors on a netlist of the IC. A test vector may include a pattern (e.g., a pattern of stimuli at the input) and an expected result.

### SUMMARY

Aspects of a method for verifying a test vector of an integrated circuit (IC) are disclosed. The method includes simulating a pattern on a netlist of the IC and selecting at least one path in the netlist of the IC based on a result of the simulation. The method further includes generating timing information of the at least one path and storing the timing information of the at least one path. In one example, the method includes selecting multiple paths in the netlist of the IC based on the result of simulation.

Aspects of an apparatus for verifying a test vector of an integrated circuit (IC) are disclosed. The apparatus includes a memory and at least one processor coupled to the memory. The at least one processor is configured to simulate a pattern on a netlist of the IC, to select at least one path in the netlist of the IC based on a result of the simulation, to generate timing information of the at least one path, and to store the timing information of the at least one path.

Aspects of a computer program product for verifying a test vector of an integrated circuit (IC) are disclosed. The computer program product is stored on a computer-readable medium and includes code that, when executed on at least one processor, performs the steps for verifying the test vector of the IC. The steps include simulating a pattern on a netlist of an integrated circuit (IC), selecting at least one path in the netlist of the IC based on a result of the simulation, generating timing information of the at least one path, and storing the timing information of the at least one path.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 illustrates a wireless communication device and communication systems in which an exemplary embodiment may be applied.

FIG. 2 is a block diagram of a wireless communication device in which an exemplary embodiment may be applied.

FIG. 3 is a flow chart of an example of an IC design methodology.

FIG. 4 is a flow chart of an exemplary embodiment of an IC design methodology.

FIG. 5 is a diagram illustrating an example of selecting at least one path in a netlist of an IC based on a simulation result.

FIG. 6 is a conceptual data flow diagram illustrating the data flow between different modules/means/components in an exemplary apparatus.

FIG. 7 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of IC design will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), electronically erasable programmable ROM (EEPROM), compact disk (CD) ROM (CD-ROM), or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

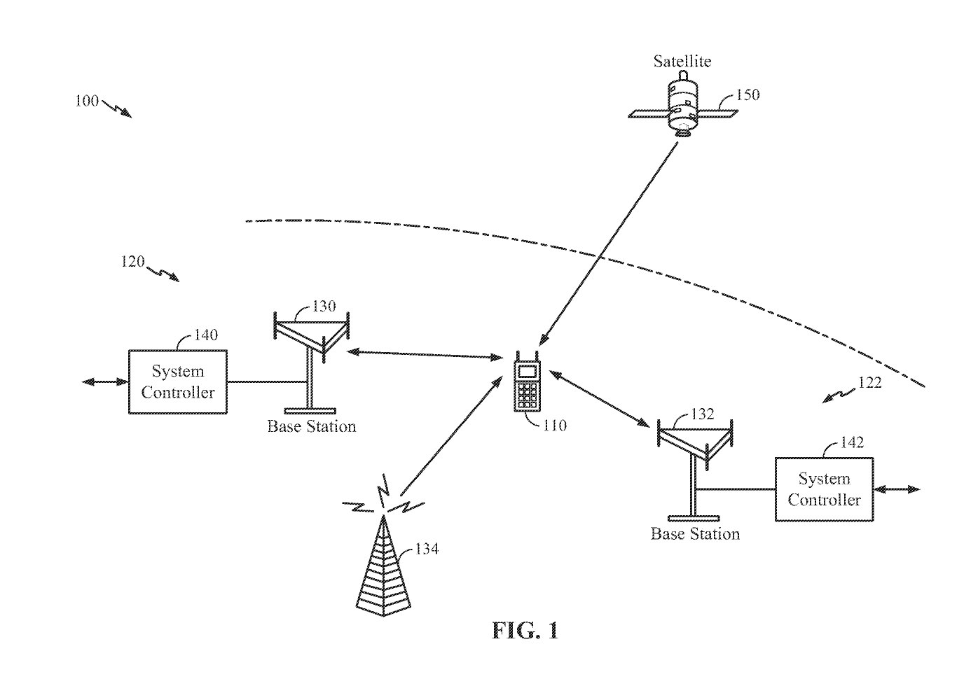

FIG. 1 illustrates a wireless device (e.g., wireless device 110) and communication systems (e.g., wireless systems 120 and 122) in which an exemplary embodiment may be applied. The wireless systems 120, 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), CDMA 1x or cdma2000, Time Division Synchronous Code Division Multiple Access (TD-SCDMA), or some other version of CDMA. TD-SCDMA is also referred to as Universal Terrestrial Radio Access (UTRA) Time Division Duplex (TDD) 1.28 Mcps Option or Low Chip Rate (LCR). LTE supports both frequency division duplexing (FDD) and time division duplexing (TDD). For example, the wireless system 120 may be a GSM system, and the wireless system 122 may be a WCDMA system. As another example, the wireless system 120 may be an LTE system, and the wireless system 122 may be a CDMA system.

For simplicity, the diagram 100 shows the wireless system 120, including one base station 130 and one system controller 140, and the wireless system 122, including one base station 132 and one system controller 142. In general, each wireless system may include any number of base stations and any set of network entities. Each base station may support communication for wireless devices within the coverage of the base station. The base stations may also be referred to as a Node B, an evolved Node B (eNB), an access point, a base transceiver station, a radio base station, a radio transceiver, a transceiver function, a basic service set (BSS), an extended service set (ESS), or some other suitable terminology. The wireless device 110 may also be referred to as a user equipment (UE), a mobile device, a remote device, a wireless device, a wireless communications device, a station, a mobile station, a subscriber station, a mobile subscriber station, a terminal, a mobile terminal, a remote terminal, a wireless terminal, an access terminal, a client, a mobile client, a mobile unit, a subscriber unit, a wireless unit, a remote unit, a handset, a user agent, or some other suitable terminology. The wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, or some other similar functioning device.

The wireless device 110 may be capable of communicating with the wireless system 120 and/or 122. The wireless device 110 may also be capable of receiving signals from broadcast stations, such as the broadcast station 134. The wireless device 110 may also be capable of receiving signals from satellites (such as the satellite 150) in one or more global navigation satellite systems (GNSS). The wireless device 110 may support one or more radio technologies for wireless communication such as GSM, WCDMA, cdma2000, LTE, 802.11, etc. The terms “radio technology,” “radio access technology,” “air interface,” and “standard” may be used interchangeably.

The wireless device 110 may communicate with a base station in a wireless system via the downlink and the uplink. The downlink (or forward link) refers to the communication link from the base station to the wireless device, and the uplink (or reverse link) refers to the communication link from the wireless device to the base station. A wireless system may utilize TDD and/or FDD. For TDD, the downlink and the uplink share the same frequency, and downlink transmissions and uplink transmissions may be sent on the same frequency in different time periods. For FDD, the downlink and the uplink are allocated separate frequencies. Downlink transmissions may be sent on one frequency, and uplink transmissions may be sent on another frequency. Some exemplary radio technologies supporting TDD include GSM, LTE, and TD-SCDMA. Some exemplary radio technologies supporting FDD include WCDMA, cdma2000, and LTE.

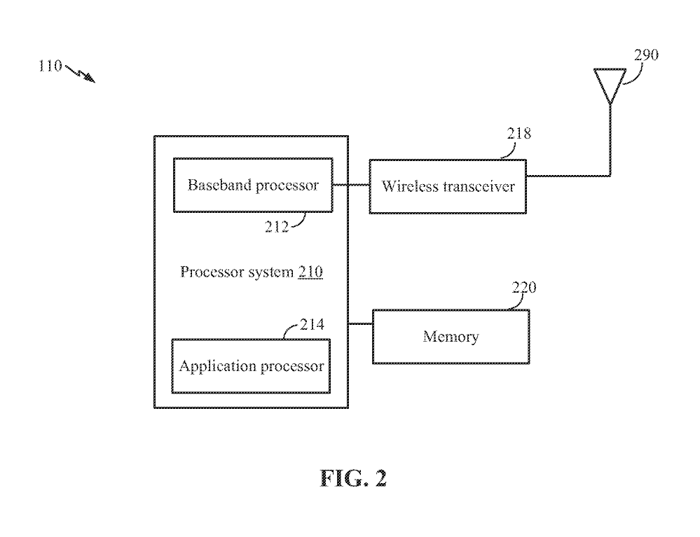

FIG. 2 illustrates a block diagram of a wireless communication device (such as the wireless device 110) in which an exemplary embodiment may be applied. The wireless transceiver 218 communicates with an antenna 290 for supporting the various wireless bi-directional communications described above. For example, the wireless transceiver 218 performs the radio frequency (RF) functions of the wireless device 110. The wireless transceiver 218 may receive a digital signal for transmission from the baseband processor 212, and convert the digital signal to an analog RF signal. The analog RF signal is provided to the antenna 290 for transmission. The wireless transceiver 218 may further receive an RF signal from the antenna 290 and convert it to a digital signal. The wireless transceiver 218 may provide the digital signal to the baseband processor 212 for processing.

The wireless device 110 includes the processor system 210, which includes the baseband processor 212 and the application processor 214. The baseband processor 212 communicates with the wireless transceiver 218. In one example, the baseband processor 212 receives data (e.g., from the application processor 214) for transmission and modulates the data. The modulated data is provided to the wireless transceiver 218 as the digital signal for transmission. The baseband processor 212 may further receive a digital signal from the wireless transceiver 218. The baseband processor 212 may demodulate the received digital signal and obtain the data carried by the digital signal. The application processor 214 operates and processes the various functions of the wireless device 110 (e.g., music player, web browsers, video streaming applications, etc.). In that regard, the application processor 214 may include a graphic unit for displaying an image, a global positioning unit for locating the wireless device 110, an audio unit for telephony and music applications, and/or a connectivity unit for WiFi, near field communication, and Bluetooth functions. The processor system 210 communicates with the memory 220. Examples of the memory 220 include static random access memory (SRAM), dynamic random access memory (SRAM), flash memory, read only memory (ROM), registers, a hard disk, a removable disk, a CD-ROM, and so forth.

Embodiments described herein provide a method and apparatus for verifying timing of (test) vectors using a single simulation. In IC design, the timing of the designs may need to be verified across various corners. A corner is a condition for the design in question and may relate to process, voltage, or temperature. During the design process, the timing may need to be verified over 25 different corners. It may not be practical to simulate every test vector across all of these corners. Given the number of test vectors, even verification across one corner can be prohibitive. As an example, an exemplary embodiment may be applied to the design of the baseband processor 212 or the application processor 214. While processors in wireless applications are cited as examples, persons of ordinary skill in the art would readily recognize that the scope of the exemplary embodiment is not so limited. The exemplary embodiment may be applied to IC design in general and to applications outside of wireless communication.

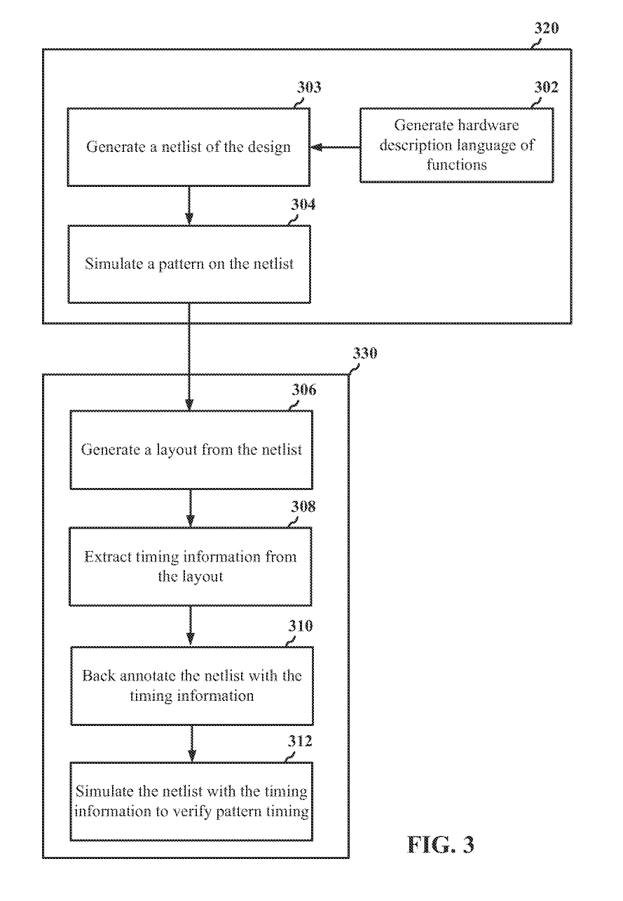

FIG. 3 is a flow chart of an example of IC design methodology. The IC design methodology includes a frontend design methodology 320 and a backend design methodology 330. The frontend design methodology 320 provides that, at 302, the functions of the IC are generated in hardware description language (examples of the hardware description language include Verilog). At 303, a netlist of the design is generated (e.g., synthesized) based on the functions of the IC defined by the hardware description language. The netlist may be of various levels of abstractions. For example, the netlist may be a transistor-level netlist, a gate-level netlist, a register-transfer level (RTL) netlist, or a combination of the above.

At 304, a pattern on the netlist is simulated. The simulation may include timing-aware and/or power-aware simulations to verify the timing of the netlist, e.g., under one or more power conditions. Examples of such simulation may include Simulation Program with Integrated Circuit Emphasis (SPICE) and other SPICE-like circuit simulators. The simulations may further include logic simulations to verify the logic/functionality of the netlist. Examples of the logic simulation may include a zero-delay gate simulation, which may not be timing-aware but runs at a faster rate. The pattern may include test patterns, which include stimuli (e.g., inputs) and responses to the stimuli (e.g., expected correct outputs).

The backend design methodology 330 provides that, at 306, the layout is generated from the netlist. The layout generation may utilize standard cells for the logic gates and place-and-route for the chip layout. At 308, timing information is extracted from the layout. In one example, the timing information may take into account of the loadings of the interconnects. At 310, the netlist is back-annotated with the timing information. For example, the interconnect load may be added or attached to the netlist. At 312, the netlist with the back-annotated timing information is simulated (as discussed with 304) to verify the pattern (e.g., test vector) timing.

In one aspect, the processes illustrated in FIG. 3 may be costly from a computing resource and schedule perspective. Multiple gate-level simulations may need to be run with specific timing needs to verify the test vector timing (e.g., at 304 and at 312). These numerous simulations may need to be performed at many different processes, voltage, and temperature conditions.

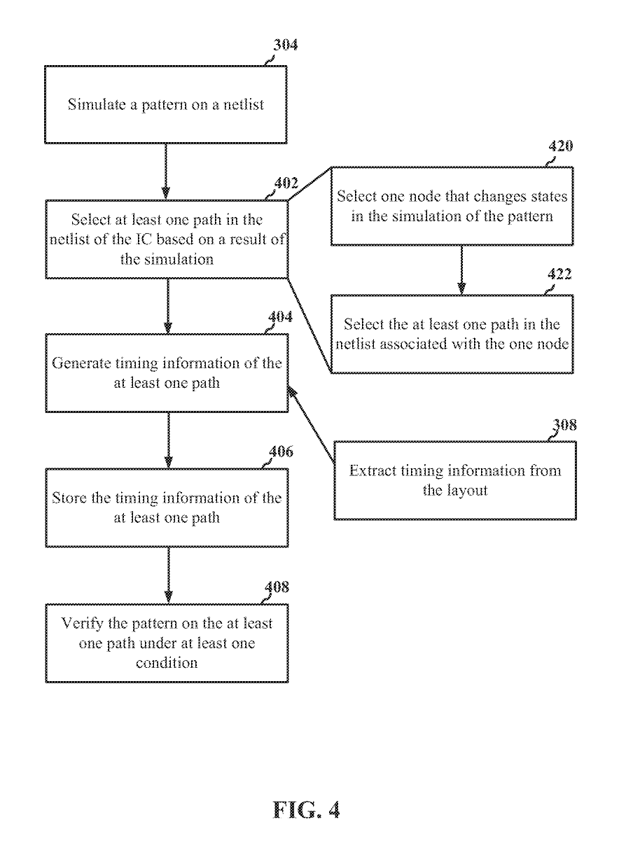

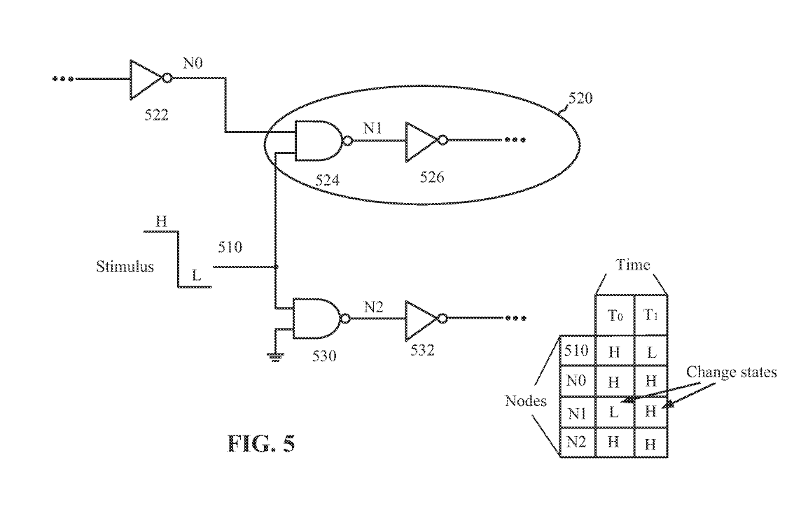

FIG. 4 is a flow chart of an exemplary embodiment of IC design methodology. At 304, a pattern is simulated on the netlist. This step may be the same as described in FIG. 3. For example, the simulation may be a zero-delay gate simulation to verify the functionality of the netlist. By using an existing process in the design methodology, the exemplary embodiment may be implemented with reduced overhead. At 402, at least one path in the netlist of the IC is selected based on a result of the simulation. FIG. 5 is a diagram illustrating an example of selecting at least one path in a netlist of an IC based on a simulation result. FIG. 5 includes a NAND gate 524 and a NAND gate 530. The NAND gate 524 receives an input N0 from the inverter 522 and the input 510 and provides an output at Node N1. The inverter 526 receives as input the Node N1. The NAND gate 530 receives inputs from input 510 and a low level (ground) and provides an output at Node N2. The inverter 532 receives as input the Node N2. At Time T₀, before an application of a stimulus at input 510, the Nodes NO and the input 510 are both in a high state and therefore, the Node N1 is at a low state. The NAND gate 530 outputs a high state at the Node N2 because of the GND input. At T₁, a pattern is applied to the netlist of the circuits of FIG. 5, and a stimulus is applied at the input 510. The input 510 changes states to a low state, and in response, the Node N1 likewise changes states to a high state. The Node N1 in the pattern simulation changes states and is selected (420). The path 520 in the netlist is associated with the Node N1 and is also selected (422). In one implementation, the path 520 includes input 510, NAND gate 524, Node N1, Inverter 526, and upstream and downstream nodes and logic elements that change states. The Node NO need not be selected as part of the path 520 since it does not change state. The Node N2 remains at the high state, and the NAND gate 530 and the inverter 532, which are not associated with the Node N1, are not selected. Thus, certain paths in the netlist are not selected.

The step 422 provides selecting the at least one path in the netlist associated with the one node and may be illustrated by the following exemplary algorithm:

I. Determine which registers, inputs, or signal generators are the source (or potential source) of the transition.

a. Select and store the gates or input pads driving that node.
i. If the gate is an edged triggered storage register element, continue tracing from the edge sensitive signal only (usually a clock).

b. Select and store all the nodes that change state and that drive those gates.
i. Some nodes that change state may be discarded if they are deemed to be immaterial. Common examples of this include:
   1. Input changes to a tristable buffer that is in tristate.
   2. Input changes to an AND or OR gate that are non-controlling, such as if the change occurs in a previous clock cycle.

c. Repeat steps a and b until the potential sources of the node state change are identified.

II. Determine which registers or outputs are the destination of the transition.

a. Select the gates receiving that node state change.
i. If the gate is an edged triggered storage register element, begin tracing back on the edge sensitive signal (usually a clock), as described in step I, and stop tracing forward.

b. Select the nodes that change state and that are driven by those gates.

c. Repeat steps a and b until all the destinations of the node state change are identified.

III. Select from the set of all inputs, outputs, registers, gates, and nodes associated with the original node that changed state.

Referring back to FIG. 4, at 404, timing information of the selected at least one path (e.g., path 520) is generated. In one example, the selected at least one path (e.g., path 520) is analyzed using static timing analysis (STA). STA analyzes a netlist with fixed delays. In one aspect, the STA is not considered as a simulation. In another aspect, the STA is able to analyze the entire netlist (e.g., in this case, the selected at least one path 520) in a timely fashion and generate timing information. Examples of the timing information may include a critical path in the netlist of the path 520, a maximum frequency at which the path 520 may operate, or a setup time and hold time of an element in the path 520. In one example, timing information may be extracted from the layout (308). The standard cell library is characterized under at least one condition (e.g., process, voltage, and temperature condition). The STA calculates timing for the at least one path under the at least one condition, using the results of the extracted timing information and the standard cell library characterization as inputs. The STA my further determine whether the data in the at least one path is received in the required number of clock cycles.

At 406, the timing information of the path 520 is stored. In one example, multiple paths are selected, and the timing information of each path is stored associated with the path. At 408, the pattern on the at least one path 520 is verified under at least one condition. For example, the pattern on the path 520 may be verified using the STA over the various PVT corners. Because the STA covers all elements of the path 520, using the STA to analyze the selected path 520 may yield 100% coverage. In case a timing fault is found under the STA, additional verification or simulation may be performed to examine the timing fault further. In this manner, the design weaknesses in the IC design may be quickly identified and therefore, addressed.

In another example, the exemplary embodiment may be applied to verify the design on an IC itself. For example, when an IC chip returns from a foundry, there may be little time to bring-up the device on an automated test equipment (ATE) so that units may be delivered to development teams. It may be difficult to bring-up the multitude of circuit elements and cores on a chip and verify that the timing (of the test pattern, etc.) is correct on the ATE within this limited time period. Steps 406 and 408 may thus be applied to the chip testing by verifying the pattern on the IC chip based on testing the extracted path over a plurality of conditions and the stored timing information.

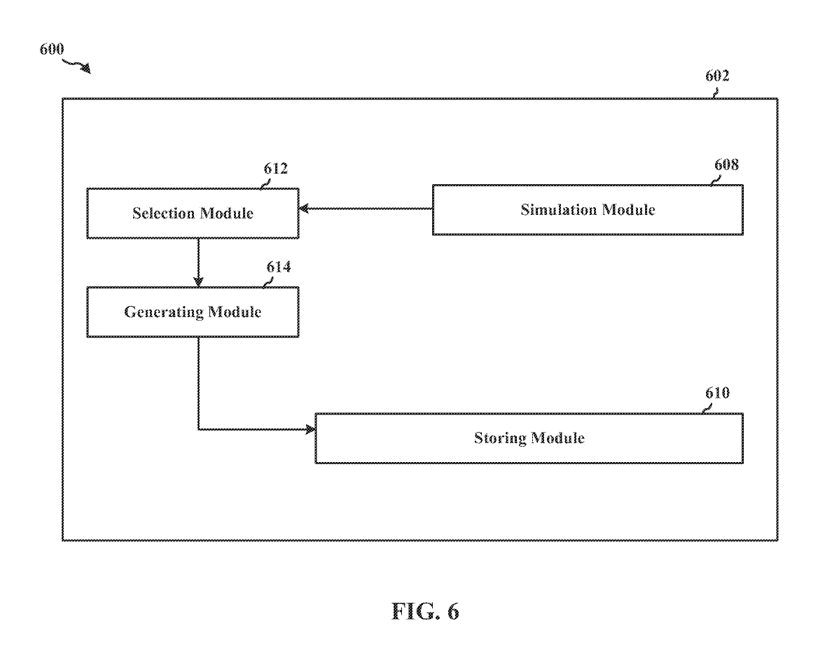

FIG. 6 is a conceptual data flow diagram 600 illustrating the data flow between different modules/means/components in an exemplary apparatus 602. The apparatus 602 may be a computer or a processor coupled to a memory for initiating the modules in hardware or software. For example, for a firmware and/or software implementation, the methodologies may be implemented with the modules (e.g., procedures, functions, and the like) that perform the steps described in FIG. 4. Any machine-readable medium tangibly embodying instructions may be used in implementing this routine. The apparatus 602 includes a simulation module 608 that simulates a pattern on a netlist, a selection module 612 that selects at least one path in the netlist of the IC based on a result of the simulation, a generating module 614 that generate timing information of the at least one path, and a storing module 610 that stores the timing information of the at least one path.

The apparatus may include additional modules that perform (or provide the means for) each of the steps of the algorithm in the aforementioned flow chart of FIG. 4. As such, each step in the aforementioned flow charts of FIG. 4 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

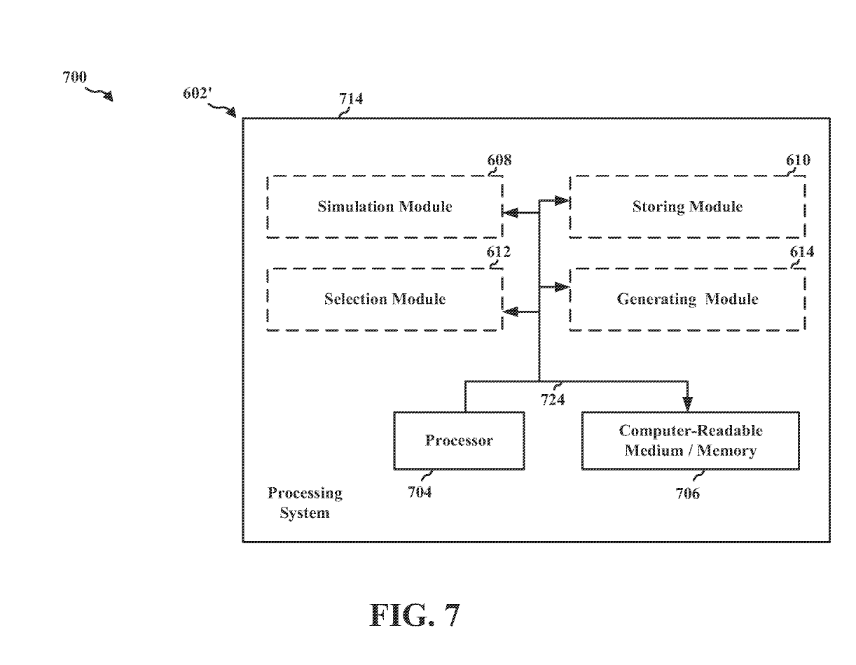

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 704, the modules 608, 610, 612, 614 and the computer-readable medium/memory 706. The bus 724 may also link various other circuits such as timing sources, peripherals, voltage regulators, and power management circuits, which are well known in the art, and therefore, will not be described any further.

The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system further includes at least one of the modules 608, 610, 612, and 614. The modules may be software modules running in the processor 704, resident/stored in the computer readable medium/memory 706, one or more hardware modules coupled to the processor 704, or some combination thereof.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for verifying a test vector of an integrated circuit (IC), comprising:
simulating a pattern on a netlist of the IC;
selecting at least one path in the netlist of the IC based on a result of the simulation;
generating timing information of the at least one path; and
storing the timing information of the at least one path.

2. The method of claim 1, wherein the pattern comprises at least one stimulus and at least one response.

3. The method of claim 2, wherein the selecting at least one path in the netlist of the IC comprises:
selecting one node that changes states in the simulation of the pattern; and
selecting the at least one path in the netlist associated with the one node.

4. The method of claim 3, wherein the simulation is a logic simulation.

5. The method of claim 3, wherein the simulation is a zero delay gate simulation.

6. The method of claim 3, wherein the timing information of the at least one path is generated by static timing analysis.

7. The method of claim 3, further comprising verifying the pattern on the at least one path under at least one condition, wherein the at least one condition includes at least one of a process, a voltage, a temperature, or a timing condition.

8. The method of claim 3, further comprising extracting timing information from a layout of the IC, wherein the generating the timing information of the at least one path is based on the extracted timing information.

9. An apparatus for verifying a test vector of an integrated circuit (IC), comprising:
a memory; and
at least one processor coupled to the memory and configured to:
simulate a pattern on a netlist of the IC;
select at least one path in the netlist of the IC based on a result of the simulation;
generate timing information of the at least one path; and
store the timing information of the at least one path.

10. The apparatus of claim 9, wherein the pattern comprises at least one stimulus and at least one response.

11. The apparatus of claim 10, wherein the at least one processor is configured to select the at least one path in the netlist of the IC by being configured to:
select one node that changes states in the simulation of the pattern; and
select the at least one path in the netlist associated with the one node.

12. The apparatus of claim 11, wherein the at least one processor is configured to simulate the pattern on the netlist of the IC using a logic simulation.

13. The apparatus of claim 11, wherein the at least one processor is configured to simulate the pattern on the netlist of the IC using a zero delay gate simulation.

14. The apparatus of claim 11, wherein the at least one processor is configured to generate the timing information of the at least one path is using a static timing analysis.

15. The apparatus of claim 11, wherein the at least one processor is further configured to verify the pattern on the at least one path under at least one condition, wherein the at least one condition includes at least one of a process, a voltage, a temperature, or a timing condition.

16. The apparatus of claim 11, wherein the at least one processor is configured to extract timing information from a layout of the IC, and wherein at least one processor is configured to generate the timing information of the at least one path based on the extracted timing information.

17. A computer program product stored on a computer-readable medium and comprising code that when executed on at least one processor performs the steps of:
simulating a pattern on a netlist of an integrated circuit (IC);
selecting at least one path in the netlist of the IC based on a result of the simulation;
generating timing information of the at least one path; and
storing the timing information of the at least one path.

18. The computer program product of claim 17, wherein the selecting the at least one path in the netlist of the IC comprises:
selecting one node that changes states in the simulation of the pattern; and
selecting the at least one path in the netlist associated with the one node.

19. The computer program product of claim 18, wherein the simulation is a zero delay gate simulation.

20. The computer program product of claim 18, wherein the timing information of the at least one path is generated by static timing analysis.
